(19) United States
(12) Patent Application Publication
(10) Pub. No.: US 2015/0310456 A1
(43) Pub. Date: Oct. 29, 2015

(54) Educational Survey System

(71) Applicants: John Vandenburgh, Murrieta, CA (US); Niki Vandenburgh, Murrieta, CA (US)

(72) Inventors: John Vandenburgh, Murrieta, CA (US); Niki Vandenburgh, Murrieta, CA (US)

(21) Appl. No.: 14/261,799

(22) Filed: Apr. 25, 2014

(51) Int. Cl. G06Q 30/02; G06Q 50/20

(52) U.S. Cl. CPC G06Q 30/0201; G06Q 50/20

(57) ABSTRACT

A system and processes for using the system to create a survey of a population for improvement in performance around a select set of categories is described. In the preferred embodiment, the process and questions are shown as applied to an educational environment. The system uses past data to refine the questions included in a survey and activities selected to have an impact in changing survey results in subsequent survey. The system includes a computerized database of survey questions and activities that are sorted through predictive equations to be most effective as a function of the demographics of the surveyed population.

### CROSS-REFERENCE TO RELATED APPLICATIONS

Not Applicable.

### TECHNICAL FIELD

The present invention relates to a system and methods for producing and using a survey to decide on a course of actions for improvements to an educational environment.

### RELATED BACKGROUND ART

Spending on education is one of the largest budget items for state governments in the United States and in fact the world. State spending in the US is augmented by federal spending as well. There have been numerous programs to improve the effectiveness and efficiency of our education system. Programs frequently judge the effectiveness of the educational system through testing of students. Standardized test scores are used as a measure of the effectiveness of the school environment to provide an education. A weakness of using just test scores as a measure of effectiveness is that teaching is often geared towards improvements in test scores. Teaching focuses on improvements in test taking to ensure continued funding and for evaluation of teachers. The focus on tests and evaluating a school performance strictly through tests often misses fundamental issue in the school and home environments that are hindering academic performance. Demographics and details of the academic and home environments are known to be most important to the students' success. Students are subject to a socio-economic environment within the walls of the school as well as when they are outside of the school environment that have a direct influence on the students success in school. Family support in education, peer drug use, bullying, gangs, financial strains, community infrastructure, availability of after school activities, tutoring, sports programs, and others are all factors that have significant impact on a student's ability to learn. These factors are rarely considered in standardized testing programs. Teaching to pass test may overlook core factors that are distracting or preventing the students from learning. Testing will not uncover these core issues that are most important in creating an effective learning environment. The students are the members of the academic environment most knowledgeable about these core factors are the last ones to be asked.

The social and environment issues affecting academic performance are not simple. What may work in one situation may fail or even worsen results in another. Any improvement program must take into account the demographics as well as a host of individual factors. It is rare that an improvement activity can be created ab initio and be effective. Improvement activities and actions will likely require iterations based upon empirical results. Even defining the issues requires accounting for demographics. Measured variables such as academic scores, teacher records, and police records are not necessarily consistent across demographics. Questionnaires and surveys are also known to be biased by the demographics of the population taking the survey. Some demographics are known to downplay issues or interpret survey questions differently.

There is a need for a system that addresses the core environmental issues affecting academic performance. There is a need for a system that interrogates those most intimately familiar with the environment. A system is needed that accounts for differences in academic environments to devise both the interrogation of issues as well as activities to address issues once found. There is a need for a system that makes use of empirical results and is self-improving. There is a need for a resource that will allow academicians to gather information, evidence and statistics on the important factors affecting their and their students' performance. There is a need for a system that accounts for the demographics of the academic population in both measurement of issues and in providing activities for improvements.

### DISCLOSURE OF THE INVENTION

A computerized resource for developing a questionnaire survey of students within an academic environment, gathering the data of student responses and analyzing the responses against norms for the student population, suggesting activities for those areas where the responses indicate a significant difference from the norms, re-surveying the population after the activities are completed and then revising the categories, questions, norms and activities is described. In one embodiment a student population is characterized by demographic vectors. The vectors include social geographic, social economic, social human and academic performance dimensions. Demographic vectors allow classification of an academic population based upon cross products or correlations of their demographic vectors. A database of survey questions appropriate to the demographic vector is presented to a user with the survey categorized to issues typically affecting the academic environment. In one embodiment the system will create a survey based upon a user selection of categories and input data that defines the demographics of the population too be tested. In one embodiment the survey is comprised exclusively of yes or no questions. The survey is administered to the population either electronically or manually and the results are compiled and compared with results of populations with similar demographics. Results of past surveys for a variety of academic populations with a range of demographics are used to define norms for questions, groups of questions and categories as a function of the demographics of the population. Results of current surveys are tested against normative results of past surveys. Categories, groups of questions and individual questions are tested for deviations from norms of past surveys for similar demographic groups. Statistically significant deviations from norms are flagged and activities are selected from a database of activities that have been previously tested to be effective in academic environments with similar demographics. Activities are completed, the population retested and effectiveness of the activities are re-evaluated. In another embodiment the accuracy of the demographic characterization is tested as part of the survey. The test of accuracy provides a secondary test of the probabilities of deviations from norms.

The methods are self-correcting and self improving. Each survey is used to refine the values for norms, the demographic vectors, and to refine activities as being effective in changing results the particular demographic and category of issue.

The techniques described here are applicable to a variety of environments other than academic. Employee performance may be assessed by a variety of means but arriving at core issues within a work environment similarly requires understanding employee perceptions and attitudes. The measurement of these parameters must likewise take into account the demographics of the employee population. Work environments like schools differ greatly by factors other than those immediately visible to the management. Employee surveys may give broadly differing results across differing demographics. Actions that work for one demographic may be ineffective or even detrimental in another demographic.

### BRIEF DESCRIPTION OF THE DRAWINGS

FIG. 1 is a schematic view of networked a computer system in which the invention may be practiced.

FIG. 2 is a high level flow chart of an embodiment of a method of practicing the invention.

FIG. 3 is a schematic block diagram showing the overall structure of the invented resource.

FIG. 4 is a block diagram showing the demographic vector definition.

FIG. 5 is a block diagram showing a survey building embodiment.

FIG. 6 is a diagram showing a survey as practiced in an embodiment of the invention.

FIG. 7 is a diagram showing access to an activity database embodiment.

FIG. 8 is a more detailed flow chart of an embodiment of the invention.

FIG. 9 is a block diagram showing the self-improvement and self-refining aspect of the invention.

### DETAILED DESCRIPTION

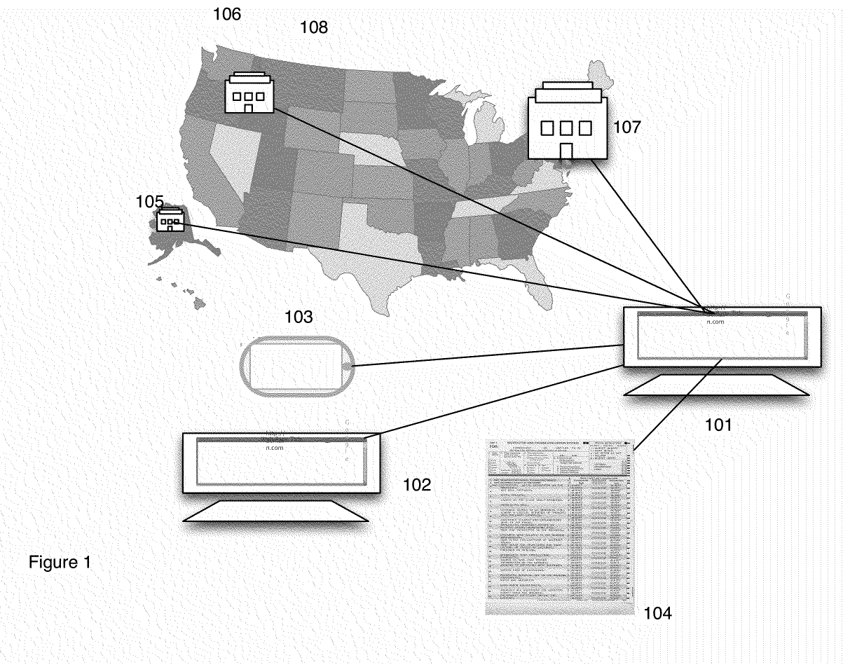

FIG. 1 shows an overview of embodiments of the invention. A networked computer 101 includes a database of past survey results taken from a variety of academic environments. The variation in demographics includes location with academic institutions located in the northeast region of the country 107, the northwest 106 and perhaps even in isolated states 105 such as Alaska. Demographics are shown for geographical variations across the US. But may also include world-wide geographically defined demographic parameters. Demographics also include the size of the academic environment from very large schools or universities 107 to very small environments with limited populations 105. The database is used to create a survey on a first networked computer that may then be distributed to participants in the academic environments for responses. The surveys may be distributed electronically to computers 102 and handheld portable electronic devices 103 or may be distributed as hardcopy on paper 104. Surveys may be taken as in a single session or surveys may be completed as a series of questions and responses that may extend over days or weeks. Results of the surveys are compiled in a networked computer 101. Here the same computer and database used to create the survey is used to compile results. In other embodiments the computational requirements of the invention may be distributed across a plurality of networked computers to the same effect. The survey provides a measure of a parameter selected by the developer of the survey, typically a teacher or other academic professional. For example it may be desired to determine whether there is a drug problem, gang, problem, academic performance problem within a schools system. In the preferred embodiment the definition of a “problem” is one where the results for a particular academic environment are statistically different from the norm for the results of other academic environments that have similar demographics.

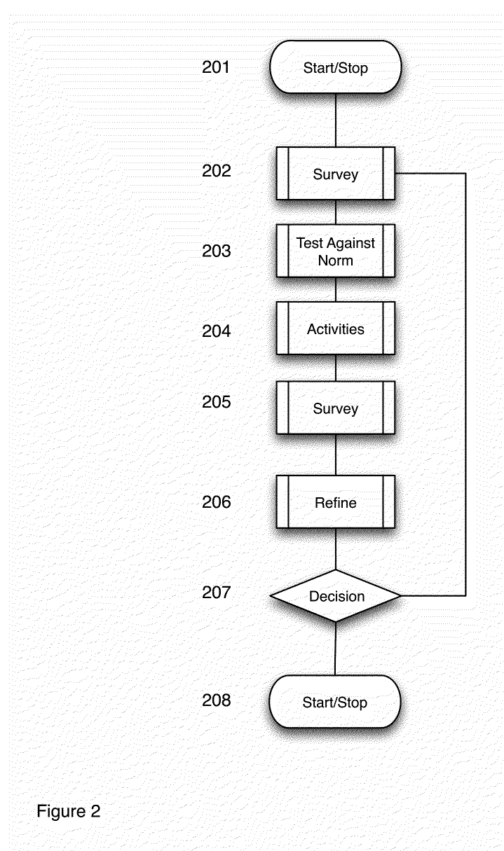

FIG. 2 shows a flow chart for a preferred embodiment of the invention. The program is begun 201 with an initiation to test the academic environment. The start includes defining categories of issues to be tested and devising a questionnaire to be administered to the members of the academic environment. In a preferred embodiment the survey is a set of questions with binary answers (yes/no or true/false) created from a pre-selected and refined database of questions that have been previously tested to provide accurate assessments. The survey is administered 202 to the members of the community. In the preferred embodiment for an academic environment the survey is administered to the students. The survey may be administered electronically or through use of pen and paper. In one embodiment the survey is given as a questionnaire to be completed at one time. In another embodiment the survey is a series of questions administered over an extended period of time. Once survey responses are collected the responses are analyzed 203. Analysis includes comparing overall results for a group of questions against results for the same group of questions taken by other populations. In a preferred embodiment the populations compared have similar demographics. In another embodiment the bias of demographic vectors is included in comparing results from different population groups. In another embodiment the results for individual questions are compared. Comparison includes comparing results in the instant survey with normative results from previous surveys. The normative results include the mean, median, most frequently selected response to a group of survey questions or to individual survey questions. In one embodiment the comparisons include statistical tests for confidence intervals for the difference between two mean results. In one embodiment a t-test as is know in the art is used. In another embodiment the results of the instant survey are tested to determine if the distribution of responses can be represented by a normal distribution and if so a t-test is applied and if not a normal distribution tests such as a Mann Whitney test as is known in the art is applied. In another embodiment the affect of the demographics of the test group is factored in prior to applying statistical tests. The result in the preferred embodiment of the test 203 is to flag those questions and category of questions that are statistically significantly different from the norms for populations in previous tests where the demographics of the two populations are measured to be equivalent. In another embodiment where the populations are not demographically equivalent and previous results allow estimates of the biases introduced by demographics the results of the instant survey are adjusted for demographics prior to comparisons to determine if the instant population differs significantly from the norm. The process then continues with selection and implementation of activities 204. In the preferred embodiment selection of activities includes selection from a database of activities that have been previously tested on populations taking the surveys and have known effectiveness in modifying the results for questions and categories of questions found to be outside the norm for populations with similar demographics. The activities may include one off activities such as bring in counselors to address specific issues or ongoing activities such as modification of procedures used within the tested environment. Upon completion or implementation of the activities the population is surveyed 205 a second time. In one embodiment the entire population surveyed in the first surveyed are surveyed again. In another embodiment only a portion of the original population is surveyed. In another embodiment the size of the population surveyed the second time is dependent upon the percentage of the population that gave a particular response and the size of the population to be surveyed to provide a statistically significant test of the effectiveness of the activity. Results are analyzed as before 203 with the additional step of refining 206 the process. Refining the process includes recalculation of norms for the population tested, refining the estimates of the effect of demographics on the norms for questions and categories of questions and refining estimates of the effectiveness of the activities 204 selected in the instant case of the process. The process further includes a decision 207 as to whether to stop the process 208 or continue through an additional iteration back to the start 202. In one embodiment the process is completed 208 once the decision survey results for the questions and category of questions fall within the norms for the survey results of like populations.

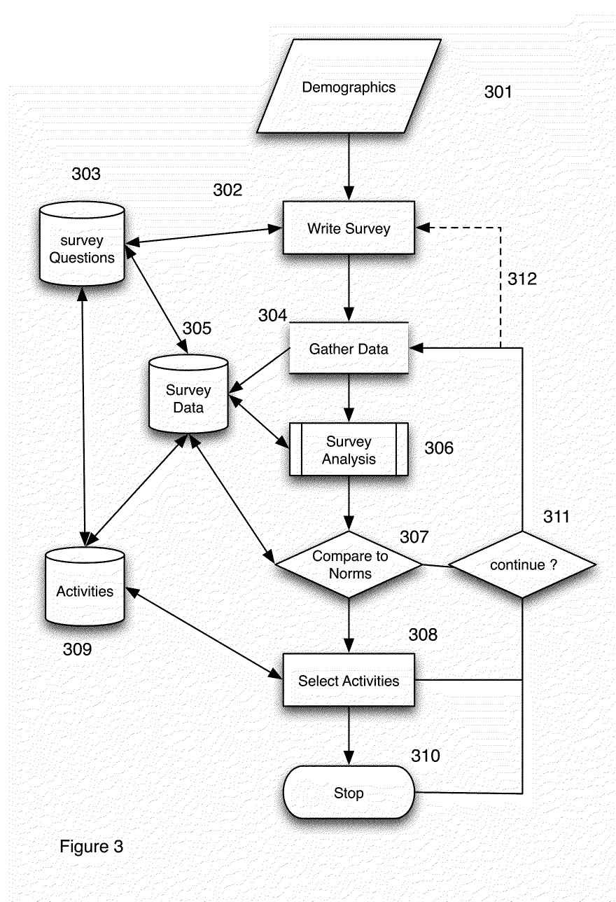

Referring now to FIG. 3 more details of embodiments of the invention are shown. A process begins with determination 301 of the demographics of the group to be surveyed. The process then proceeds to drafting 302 the survey. The survey is a series of questions that probe issues that may be present in the population to be tested. The survey questions are selected from a database of questions 303. The database includes a data file of questions, a data file of activities, a data file of the demographics of participants in past surveys and data files of the survey results for all populations the survey results taken before and after the activities. The database of questions is based upon analysis of results from previous survey data 305 and from previous activities 309. In the analysis of past survey results survey questions are selected from previous surveys on the basis of questions that consistently appeared as flagging issues by having results different from the norms for populations. That is questions are chosen that have high selectivity based upon past results. High selectivity is also based upon statistical testing of difference in results. Thus questions are also selected that give consistent results within a population. i.e. questions that have relatively lower standard deviations across like populations and within a population. Questions are filtered out of the database based upon past results including selectivity, as indicated by those questions that consistently flag issues, and precision, as indicated by questions that give consistent results. Questions that rarely pop up as flagging issues and questions that have high variability in response may be dropped from the question database to be replaced by newly formulated questions that are then screened similarly through the survey process to be retained in the database. The process is therefore self-improving. Once the survey is written 302, data is gathered 304 and fed into the database 305 for refinement and is analyzed 306. Analysis is as described in conjunction with FIG. 2 where questions and groups of questions are tested against norms for previous test results on populations with similar demographics. In another embodiment the database includes an empirically determined factor analysis wherein the demographic data is tested against survey results and is modeled such that the effect of demographic data on the survey results is calculated and the survey results are first adjusted for demographics effects before being tested against norms to flag issues and select activities. The survey analysis 306 therefore includes both comparison 307 of the instant survey against past results to flag issues in the population currently being tested, but also adjustments to the database with respect to the calculation of norms for the populations, calculating parameters to adjust norms for demographic effects and refinement of the question database as already discussed. Comparison to the norms of past surveys 307 may result in questions or categories be flagged and proceeding to suggested activities 308 or if nothing is flagged the process branches 311 to either repeat gathering of data 304 or ending the process 310. Activities are selected from an activity database 309. This database, like the survey database, includes activities that are selected as being effective in remedying issues raised through the survey. The effectiveness is measured by repeat surveys before and after the activities are done. The effectiveness is measured by the amount of change in the flagged questions or category of questions. In one embodiment the effectiveness of the activities also includes parameters related to the demographics of the population being tested. Activities are selected both as effective generally and as having been shown to be effective in past results for populations of similar demographics.

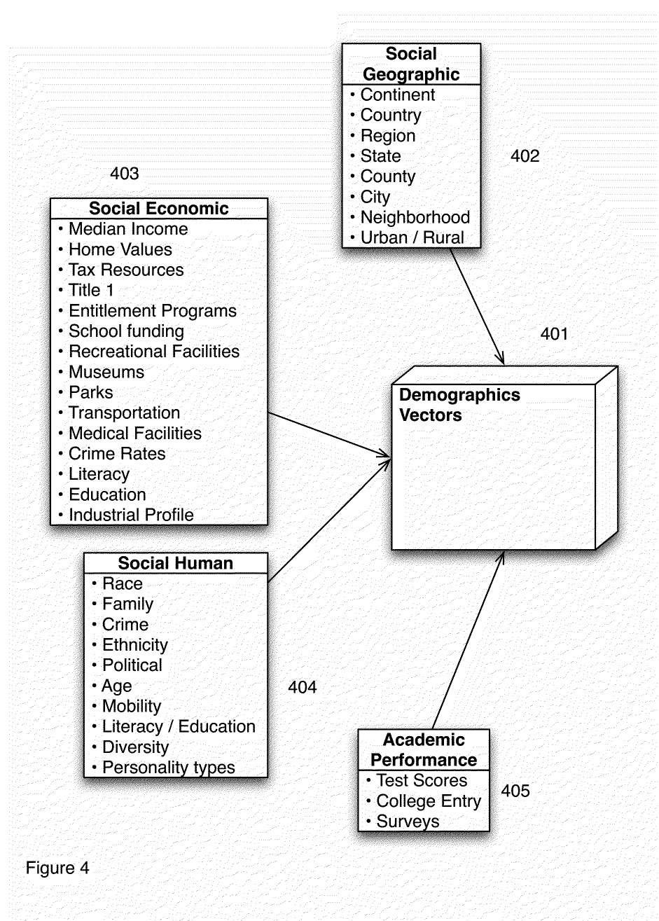

The definition of demographic vectors is illustrated in FIG. 4. Demographics are classified into several different categories: social geographic 402, Social economic 403, social human 404 and academic performance 405. All contribute to what is termed here a demographic vector 401. A demographic vector is an ordered set of demographic values. The demographic vector may be a single vector containing the data for all of the categories or a set of vectors. In one embodiment there is a demographic vector for each of the categories listed in FIG. 4. The demographic vectors are those factors that were selected as anticipated as being related to the performance in an academic environment. Applying the methods discussed here to a work environment would likely select a different set of demographic vectors. The demographic vectors are confirmed as being important to performance in the academic environment through testing for correlations with question responses and testing for correlations with changes in question responses after completions of selected activities. The social geographic demographic factors include the location of the environment being tested from the broadest level (continent) down to the narrowest city and neighborhood within a city. A further factor is describes the nature of the environment as urban or rural. The demographic vector for such a social geographic demographic category may look something like:

[North America, United States, Southwest, California, San Diego County, San Diego, Rancho Bernardo (neighborhood), urban]. A demographic vector as can be seen may include elements that are non-numeric. Demographic vectors are tested for similarity in a manner the same as normal vector algebra. If the dot product of two demographic vectors is zero the vectors are said to be orthogonal or unrelated. In the case of non-numeric data the dot product can be calculated to test for correlation. Similar to use of the Hamming distance to describe the distance between non-numeric lists a scalar product of the non-numeric vectors is calculated to test for similarity. In one embodiment the scalar product is defined as the sum of the items that are the same. For example the scalar products of the vector: A=[North America, United States, Southwest, California, San Diego County, San Diego, Rancho Bernardo (neighborhood), urban] and B=[North America, United States, Southwest, California, San Diego County, San Diego, Rancho Bernardo (neighborhood), urban] would be A·B=8. The maximum value since A is identical to B. Similarly if B=[North America, United States, Southwest, California, San Diego County, San Diego, Rancho Bernardo (neighborhood), rural] then the product A·B=7. Since the last factor urban vs. rural is now different. Numeric demographic factors are compared similarly. The scalar product is the same as conventionally considered. In this manner the similarity of demographic vectors is calculated. The populations being studied are then characterized by their similarity to other populations already tested. In one embodiment characterization includes sorting into groups of similar demographic populations. The sorting is then used to select a subset of survey questions and activities that have been tested previously to be found effective for the particular demographics. Effectiveness being defined as questions having been flagged previously as indicators of issues, questions that have standard deviations lower than other non-selected questions in the range of responses that allows for statistically significant testing versus calculated norms and activities that have been found previously effective in bringing responses to question back within the norms for a particular demographic.

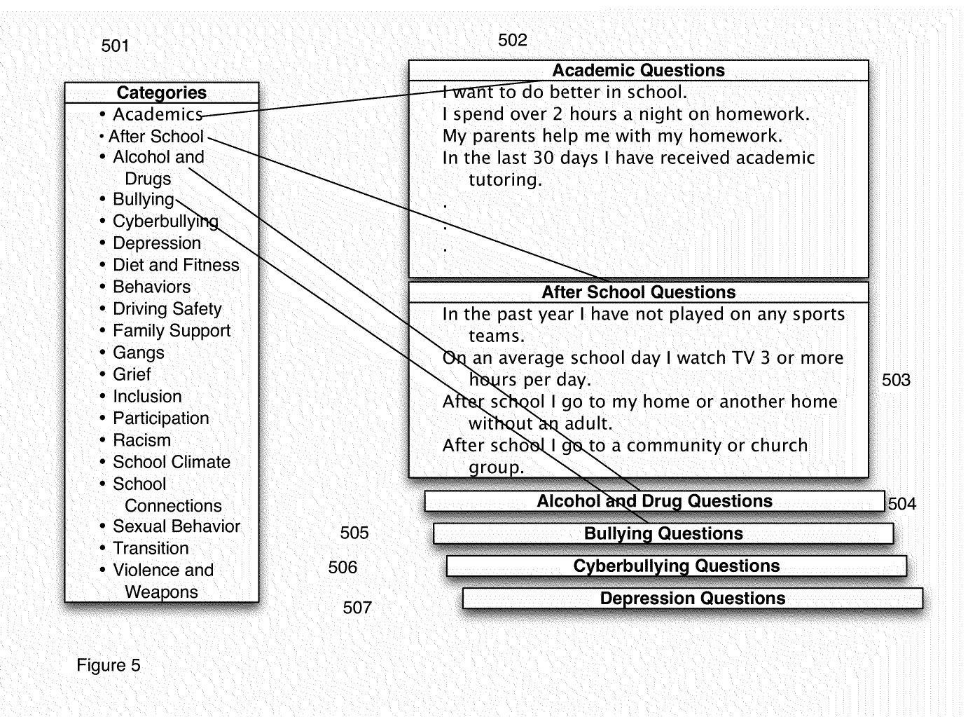

Referring now to FIG. 5 a database of survey questions is shown. The questions are subdivided into categories 501. Within each category is a set of survey questions 502-507. Details of Academic questions 502 and after school questions 503 are shown. The questions are those found to be effective in testing for issues in the designated categories. In one embodiment questions are further subdivided to those that are effective in the selected categories and for particular demographics.

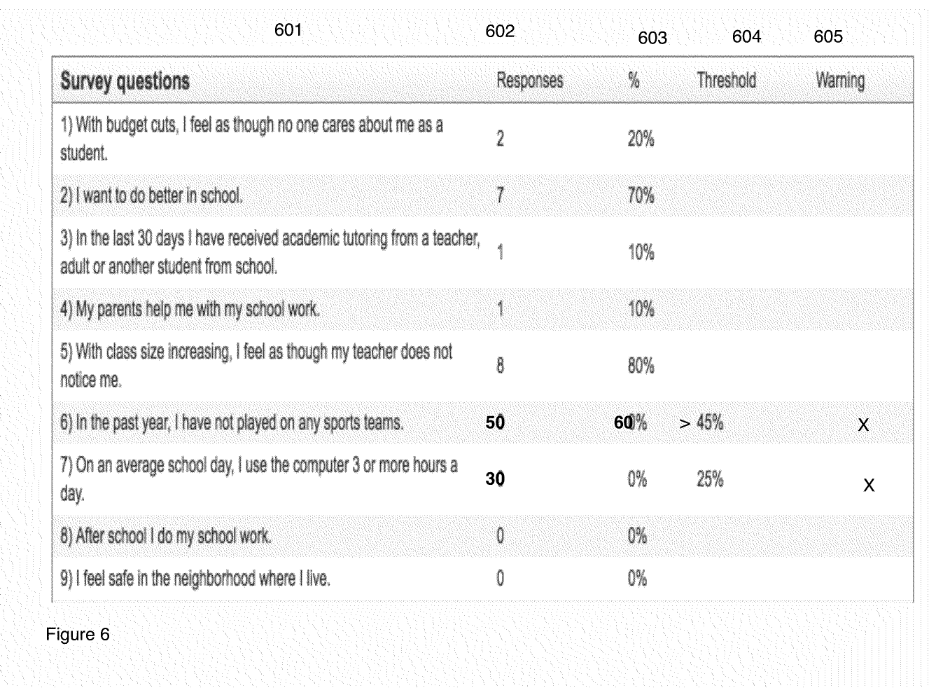

An embodiment show tabulation of survey results is shown in FIG. 6. A survey list a set of questions 601 selected from the database. The number of responses received 602, the percentage of the surveyed population that responded 604, a threshold value for a particular questions 605 are tabulated. The threshold value is a value for the particular question that would indicate a response that is statistically significantly different from the norm. In the example shown the question “I have not played on any sports teams.” has 50 responses and a threshold value of 45%. That is if greater than 45% of the respondents answered affirmatively indicating they do not participate in organized sports. The response is greater than a threshold value that would be comparing the results to the norm for the response to this particular question in survey populations with similar demographics. In one embodiment the threshold value is the average value for populations with similar demographics. In another embodiment the threshold value is that value that would indicate a significant difference from the norm for a population of similar demographics given the number of survey responses in the instant population 602 in this case 50 responses and given the number of survey responses in the database for this question. In one embodiment the threshold is set as a value that would be indicative of a 95% probability that the means are different in s student t test. The threshold values are therefore a function of the number of respondents in the current survey and the number of respondents in the database for the same question. In cases where there are too few respondents (e.g. questions 1-5 and 8-9) no threshold value is posted, as the statistically valid differences cannot be determined on so few responses. The threshold values are therefore a function of the number of responses in the current survey, the number of responses in the database of responses and the demographics of the participants in the surveys. In one embodiment questions and responses are sorted by similarity of the demographics. Populations with similar demographics are compared to the exclusion of responses from surveys with different demographics.

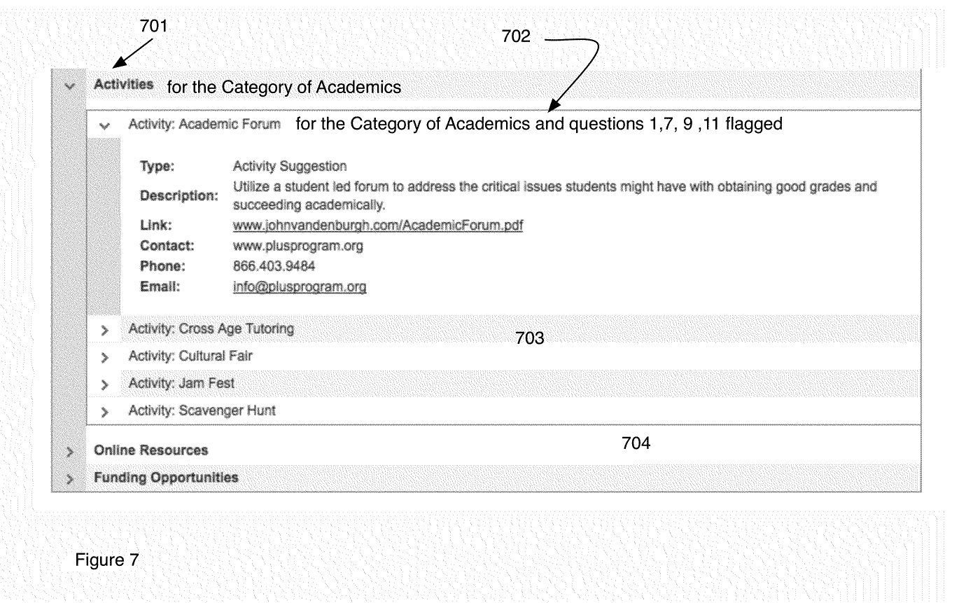

Referring now to FIG. 7 a view of information contained in the activities database is shown. The database includes activities that are sorted and specific to a particular category 701 of survey questions and activities that have been found effective in addressing a particular set of survey questions 702. Effectiveness is as already discussed is determined by selection of the activities that have been tested previously on populations and have been shown to change the results obtained on follow up surveys in the category and on the particular questions. In the preferred embodiment effectiveness is specific to a demographic group. The database further includes a selection of additional activities 703 and other resources 704 that are known to be pertinent to changing survey results in the category and for particular questions in the category. The additional activities and resources are filtered by demographics in a preferred embodiment.

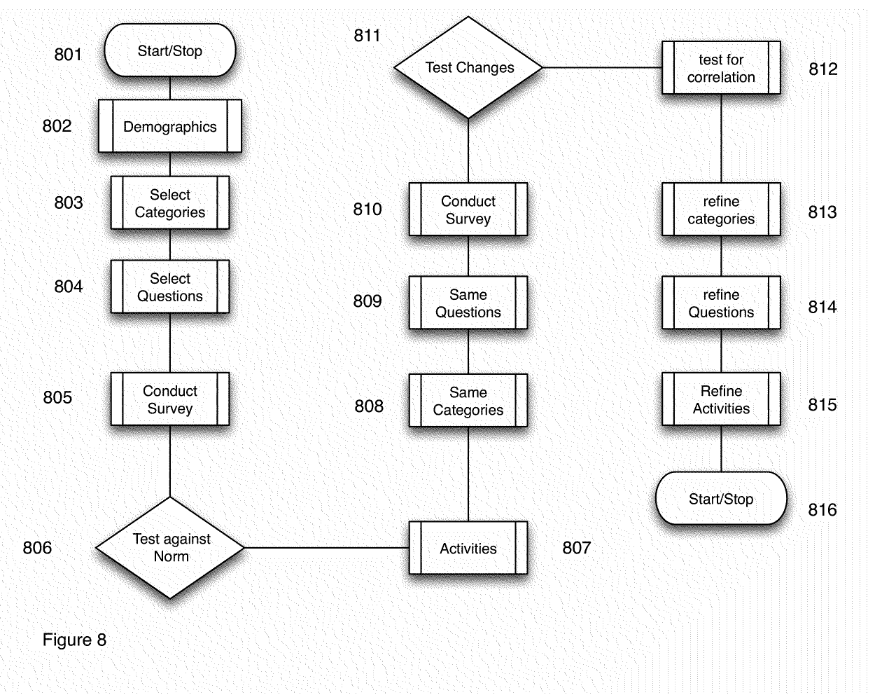

The flow chart of an embodiment that is used to refine the database is shown in FIG. 8. The process is begun 801 by the administration of an environment deciding to do a survey process for self-improvement. The demographics of the population are tabulated 802 resulting is a set of demographic vectors as already described. The demographic vectors are then compared with the vectors for populations that are included in the database as having been previously surveyed. In a preferred embodiment the comparison is through scalar products of the demographic vectors with sorting of the demographics into groups with largest mutual scalar products. Categories to be surveyed are then selected 803 and a set of survey questions from the categories are selected 804. The survey questions are those that have been found effective for the particular demographics as already discussed. A survey is conducted 805 and the results are tested against the norms 806 for populations having similar demographics. Activities are selected and implemented 807 for those questions and categories flagged to being outside of the norms. Again activities are subdivided to those previously found to be effective. The survey process is repeated 810 after completion of the activities using the same categories 808 and same questions 809. And the results are tested 811 for statistically significant changes from the previous survey 806 on the same group. The refinement process includes testing for significant differences in survey results on the same population taken at different times before and after an activity is completed. The results are tested 812 for correlation between completion of the activity and anticipated change in survey results. Previous survey results provide an estimate of the expected change in results for a particular survey question or for a particular collection of questions. Here 612 the current survey is tested to see if the same model can be statistically shown to apply. The process then proceeds to refine the database model in the form of categories 813, questions 814 and activities 815. Once refined the process is complete 816. New predictive parameters, selecting of effective questions and effective activities as a function of demographics are stored in the database to be used in the next survey.

In one embodiment the selected survey questions, activities and results of the survey after the activities are used to estimate the parameters A, B, C and D in a predictive equation represented as:

Delta Survey Results=A*Activity+B*demographics+C*(activity)*(demographics)+D*survey results [1]

The purpose of the survey is to flag issues and select activities that are anticipated to change results for those issues. The predictive equation [1] is generated from past results and is used to guide the administration or managers. That is they can anticipate a predicted change in the survey results (Delta Survey Results) as a function of the Activity selected, the demographics of the population, cross terms of activity and demographics and the first round of survey results. Each pass through the survey process with a survey, activity and re-survey is used by the system to refine the parameters A, B, C and D in the predictive equation to then allow for selecting activities by subsequent users of the process in selecting survey questions and activities that are most effective.

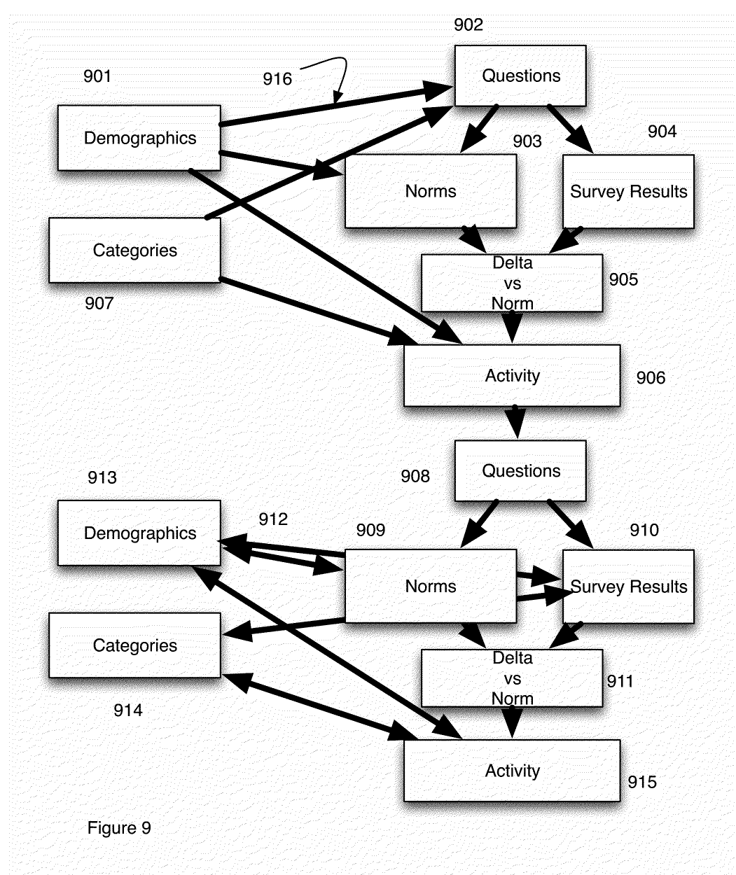

FIG. 9 shows a block diagram of data flow for the invented system and process. The arrows 916 show the direction data flows. In initiating a survey Demographics 901 and categories 907

are used to select a set of questions 902 that are used to obtain survey results 904. The Demographics and questions from past surveys determine the norms 903 for individual questions and/or groups of questions. The survey results 904 and Norms 903 determined from past surveys are used in comparisons 905. The comparisons 905 along with the categories of questions and demographics all feed into selecting activities 906 that have previously tested as effective. Once completed information from the activities are retested 908. In the subsequent analysis the norms 909 and survey results now also feed back into the database of demographics and categories as the model of what activities are effective in modifying the results for a particular question or category and for a particular demographic are refined. The refinement may change the predictive algorithm of effectiveness. In another embodiment questions are dropped as being effective in flagging issues and activities are dropped as failing to be effective in changing the results for subsequent surveys. The survey results are compared 911 with the norms a second time and activities are selected 915 and also refined as to their estimated effectiveness on the basis of demographics and in particular categories 914.

### SUMMARY

A system and processes for using the system to create a survey of a population for improvement in performance around a select set of categories is described. In the preferred embodiment, the process and questions are shown as applied to an educational environment. The system uses past data to refine the questions included in a survey and activities selected to have an impact in changing survey results in subsequent survey. The system includes a computerized database of survey questions and activities that are sorted through predictive equations to be most effective as a function of the demographics of the surveyed population.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

I claim:

1. A system for conducting a survey of a population said system comprising:
a) a computer,
b) a database said database including:
i) a data file of questions for the survey said data file of questions separated into categories,
ii) a data file of activities,
iii) a data file of demographic vectors,
c) a computer program to program the computer to perform operations, said program including:
i) programmed instructions to calculate differences between the norm for the survey questions compared with norms calculated for prior surveys, where norms are one selected from: average answers to the survey, median of the answers to the survey, most probable answers to the survey,
ii) programmed instructions to control the computer to select questions for a survey based upon results of prior surveys applied to different populations with similar demographic vectors said questions selected on the basis of having resulted in survey results different from the historical norm of past surveys and resulting in lower standard deviations for results as applied to prior surveys,
iii) programmed instructions to calculate differences between the norm for the survey questions compared with norms calculated for prior surveys,
iv) programmed instructions to control the computer to select activities from the data file of activities on the basis of those activities that have been shown to result in changes to the survey results for the selected questions when the activities are conducted with populations of similar demographic vectors from the previous surveys.

2. The system of claim 1 further including programmed instruction to calculate a predictive equation based upon survey results, said predictive equation providing an estimate of the expected change in survey results for the selected questions after completion of selected activities.

3. The system of claim 2 where the predictive equation includes parameters for survey questions, population demographics and selected activity.

4. The system of claim 3 where the parameters are estimated each time a survey is conducted, followed by an activity and another survey.

5. A method for conducting a survey on a population said method comprising:
a) selecting a population to be surveyed,
b) selecting a category of questions to include in the survey,
c) cataloging the demographics of the population,
d) selecting questions from a database of question in each of the categories, said questions selected upon the results of their use in prior surveys,
e) collecting the results of the population's answers to the selected survey questions,
f) comparing the population's answers to the survey to answers given by different populations to the same questions said different populations having similar demographics vectors to the population being surveyed,
g) selecting activities from a database of activities on the basis of the comparison of the population's answers to the survey to answers given by different populations
h) conducting the same survey on at least a portion of the same population a second time after completion of the selected activities,
i) comparing the population's answers to the survey to the answers given by the population prior to conducting the activities.

6. The method of claim 5 further including calculating a predictive equation based upon survey results, said predictive equation providing an estimate of the expected change in survey results for the selected questions after completion of selected activities.

7. The method of claim 6 where the predictive equation includes parameters for survey questions, population demographics and selected activity.

8. The method of claim 7 where the parameters are estimated each time a survey is conducted, followed by an activity and another survey.
